(19) United States
(12) Patent Application Publication
(10) Pub. No.: US 2022/0379648 A1
(43) Pub. Date: Dec. 1, 2022

(54) IMAGE FORMING APPARATUS

(71) Applicant: FUJIFILM Corporation, Tokyo (JP)

(72) Inventors: Takashi MITSUYASU, Kanagawa (JP); Hidetoshi Kawasaki, Kanagawa (JP)

(73) Assignee: FUJIFILM Corporation, Tokyo (JP)

(21) Appl. No.: 17/818,915

(22) Filed: Aug. 10, 2022

Related U.S. Application Data
(63) Continuation of application No. PCT/JP2020/049206, filed on Dec. 28, 2020.

(30) Foreign Application Priority Data
Mar. 19, 2020 (JP) 2020-050064

(51) Int. Cl. B41M 7/00

(52) U.S. Cl. CPC B41M 7/0018

(57) ABSTRACT

An image forming apparatus includes: a pretreatment section that applies a precoat liquid to a printing surface of a continuous recording medium to be transported; a printing section that sprays ink onto the continuous recording medium to which the precoat liquid is applied; and a transport section that transports the continuous recording medium along a predetermined path. The transport section includes at least one pass roller that is disposed between the pretreatment section and the printing section, the pass roller transporting the continuous recording medium to which the precoat liquid is applied toward the printing section and coming into contact with the printing surface of the continuous recording medium. A surface of the pass roller is subjected to water-repellent finishing for the precoat liquid.

### CROSS REFERENCE TO RELATED APPLICATIONS

The present application is a Continuation of PCT International Application No. PCT/JP2020/049206, filed on Dec. 28, 2020, which claims priority to Japanese Patent Application No. 2020-050064, filed on Mar. 19, 2020. Each application above is hereby expressly incorporated by reference, in its entirety, into the present application.

### BACKGROUND

### Technical Field

The present disclosure relates to an image forming apparatus.

### Related Art

As an image forming apparatus that forms an image on continuous paper such as roll paper, an inkjet type image forming apparatus that sprays ink onto the continuous paper transported by a transport section is known (for example, JP2016-002672A). In such an image forming apparatus, an image is formed by performing a pretreatment step of applying a precoat liquid containing a component for aggregating coloring material components of ink and a solvent to the continuous paper, and then performing a printing step of spraying ink.

On the other hand, in a case where the ink is sprayed in a state where the precoat liquid applied to the continuous paper is not sufficiently dried, there is a problem that an image quality is degraded. In addition, in a case where the continuous paper is transported to the printing step in a state where the precoat liquid applied to the continuous paper is not sufficiently dried, the precoat liquid adheres to and accumulates on a pass roller disposed to change a direction of the continuous paper, in particular, a pass roller in contact with a printing surface, between the pretreatment step and the printing step. Then, the accumulated precoat liquid is gradually peeled off to generate a foreign matter, and the foreign matter causes blocking in which the sheets of continuous papers after printing adhere to each other. In a case where blocking occurs, the paper tears or the ink comes off in a case where the adhesion portion is peeled off. Therefore, a method is disclosed in which an evaporation rate of moisture and a solvent contained in the precoat liquid is set to a predetermined value such that the precoat liquid is sufficiently dried before the printing step by combining a composition of the precoat liquid with conditions of a drying step of the precoat liquid (see JP2018-138353A).

However, in a case where a large amount of heat is applied to the continuous paper in order to sufficiently dry the precoat liquid, the continuous paper is not sufficiently cooled before reaching the printing step, so that dew condensation occurs on a surface of an inkjet head in the printing step, resulting in streak-like image quality failure. Therefore, instead of the heating, it is considered to lengthen a transport path from the pretreatment step to the printing step. However, in a case where the transport path is lengthened, a size of the apparatus increases, which increases a cost of the apparatus. In addition, since paper loss increases, a running cost increases. It is also considered to install a cooling device for cooling the heated continuous paper. However, setting the cooling device increases the size of the apparatus and also increases the cost of the apparatus. In addition, since the cooling device consumes electric power, the running cost increases. On the other hand, in a case where the precoat liquid is not sufficiently dried, image quality degradation and blocking may occur as described above.

### SUMMARY OF THE INVENTION

The present disclosure has been made in view of the above circumstances, and an object thereof is to prevent streak-like image quality failure and blocking in an image forming apparatus while reducing a size of the apparatus.

An image forming apparatus according to the present disclosure comprises: a pretreatment section that applies a precoat liquid to a printing surface of a continuous recording medium to be transported; a printing section that sprays ink onto the continuous recording medium to which the precoat liquid is applied; and a transport section that transports the continuous recording medium along a predetermined path, in which the transport section includes at least one pass roller that is disposed between the pretreatment section and the printing section, the pass roller transporting the continuous recording medium to which the precoat liquid is applied toward the printing section and coming into contact with the printing surface of the continuous recording medium, and a surface of the pass roller is subjected to water-repellent finishing for the precoat liquid.

The image forming apparatus according to the present disclosure may further comprise: a drying section that is provided between the pretreatment section and the pass roller and dries the continuous recording medium to which the precoat liquid is applied.

In the image forming apparatus according to the present disclosure, a difference between surface free energy on the surface of the pass roller and surface free energy of the precoat liquid may be 10 to 35 mN/m.

In the present specification, the term “A to B” means that it is A or more and B or less. For example, the term “10 to 35 mN/m” means that it is 10 mN/m or more and 35 mN/m or less.

In the image forming apparatus according to the present disclosure, a surface roughness Ra of the pass roller may be 0.1 to 1.6.

In the image forming apparatus according to the present disclosure, a coating thickness on the surface of the pass roller by the water-repellent finishing may be 20 to 400 μm.

In the image forming apparatus according to the present disclosure, the water-repellent finishing may be coating with a fluororesin.

In the image forming apparatus according to the present disclosure, the pass roller may have a diameter of 40 to 200 mm.

In the image forming apparatus according to the present disclosure, a wrap angle of the continuous recording medium with respect to the pass roller may be 45 to 215 degrees.

In the image forming apparatus according to the present disclosure, a transport tension of the continuous recording medium may be 200 to 580 N/m.

In the image forming apparatus according to the present disclosure, an evaporation rate of water contained in the precoat liquid in the continuous recording medium carried into the printing section may be 25% to 75% by mass.

In the image forming apparatus according to the present disclosure, a path length between the pretreatment section and the printing section may be 1 to 5 m.

In the image forming apparatus according to the present disclosure, the precoat liquid may contain a latex.

In the image forming apparatus according to the present disclosure, the continuous recording medium may be coated paper.

According to the present disclosure, it is possible to prevent streak-like image quality failure and blocking while reducing a size of an apparatus.

### BRIEF DESCRIPTION OF THE DRAWINGS

FIG. 1 is a schematic view showing an overall configuration of an image forming apparatus according to the present embodiment.

FIG. 2 is a table showing evaluation results of a difference between surface free energy of various coating materials applied to a surface of a pass roller and surface free energy of a precoat liquid.

FIG. 3 is a table showing evaluation results of various conditions in an image forming apparatus according to the present embodiment.

### DETAILED DESCRIPTION

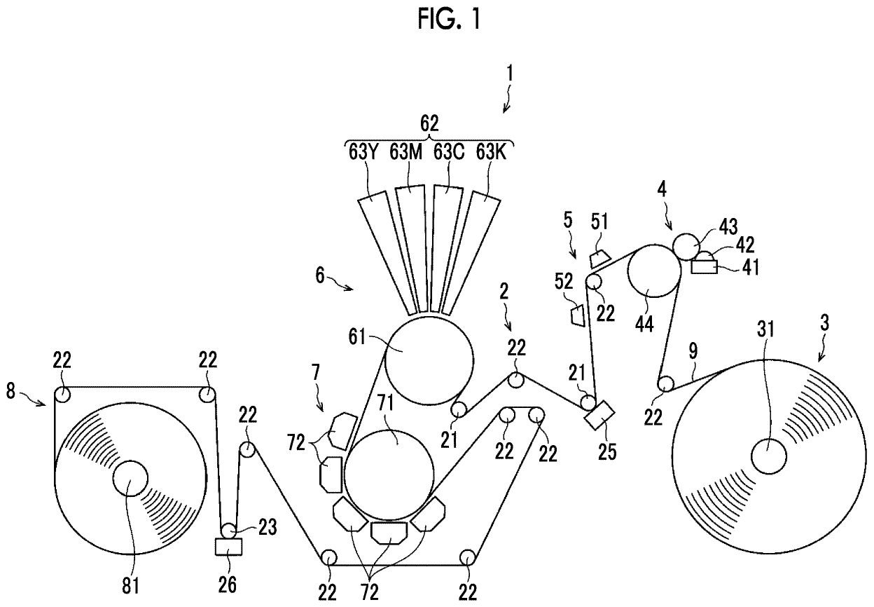

Hereinafter, embodiments of the present disclosure will be described with reference to the drawings. FIG. 1 is a schematic view showing an overall configuration of an image forming apparatus according to the present disclosure. As shown in FIG. 1, an image forming apparatus 1 according to the present embodiment is an apparatus that forms an image on a surface (one side) of continuous paper such as roll paper, and specifically, is an inkjet type printing machine. The downward direction in FIG. 1 coincides with the gravitational direction. The continuous paper corresponds to a continuous recording medium of the present disclosure.

As continuous paper 9 used in the image forming apparatus 1 of the present embodiment, coated paper obtained by coating high-quality paper or medium-quality paper with a coating agent or white clay is used.

The image forming apparatus 1 according to the present embodiment includes a transport section 2, a paper feeding section 3, a pretreatment section 4, a precoat drying section 5, a printing section 6, an ink drying section 7, and a winding section 8. The paper feeding section 3, the pretreatment section 4, the precoat drying section 5, the printing section 6, the ink drying section 7, and the winding section 8 are disposed in this order along a transport path of the continuous paper by the transport section 2.

The transport section 2 is composed of a plurality of rollers including a pass roller 21 and other rollers 22 and 23, which will be described below. The transport section 2 transports the continuous paper 9 from the paper feeding section 3 toward the winding section 8 along the transport path.

In the paper feeding section 3, the continuous paper 9 is fed. The paper feeding section 3 has an unwinding roll 31 on which the continuous paper 9 is wound in advance. The unwinding roll 31 is a drive roller driven by a motor or the like, and feeds the continuous paper 9 by being driven. The paper feeding section 3 feeds the continuous paper 9 by applying a constant tension to the continuous paper 9 together with a winding roll 81, which will be described below, by means of rotation in a direction opposite to a feeding direction of the unwinding roll 31 or a brake mechanism (not shown).

In the pretreatment section 4, a pretreatment step before performing printing (ink spraying) on the continuous paper 9 is performed. Specifically, as an undercoat before performing printing on the continuous paper 9, a precoat liquid containing an aggregating agent for aggregating coloring material components of ink and an organic solvent is applied. The pretreatment section 4 comprises a precoat liquid holding part 41, a transfer roller 42, a coating roller 43, and a backup roller 44. The precoat liquid of the precoat liquid holding part 41 is transferred to the coating roller 43 by the transfer roller 42, and is continuously applied to the continuous paper 9 sandwiched between the coating roller 43 and the backup roller 44.

In the precoat drying section 5, a precoat drying step of drying the precoat liquid applied to the continuous paper 9 in the pretreatment section 4 is performed. For this reason, the precoat drying section 5 has nozzles 51 and 52 for blowing hot air onto the continuous paper 9. The nozzles 51 and 52 blow hot air supplied from a hot air generator (not shown) toward the continuous paper 9. The precoat drying section 5 may have a drying box (not shown) for accommodating the nozzles 51 and 52 and the like therein in order to improve drying efficiency. In the precoat drying section 5, drying by emission of infrared rays may be used instead of drying with hot air. A roller in the precoat drying section 5 may be used as a heating roll to perform drying. As the heating roll, a roll in which a heater for heating is incorporated is used in order to heat a surface of the roll.

In the printing section 6, a printing step of spraying ink onto the continuous paper 9 is performed. The printing section 6 has a printing cylinder 61 around which the continuous paper 9 is wound, and a jetting part 62 for spraying ink onto the continuous paper 9 wound around the printing cylinder 61. The jetting part 62 has inkjet heads 63Y, 63M, 63C, and 63K that jets ink droplets of each color of yellow (Y), magenta (M), cyan (C), and black (K) onto the surface of the continuous paper 9. Each of the inkjet heads 63Y to 63K jets ink droplets by a method such as a thermal method or a piezoelectric method. In the present embodiment, as the inkjet heads 63Y to 63K, for example, an aqueous inkjet head having high definition of about 1200 dpi can be used.

In the ink drying section 7, an ink drying step of drying the ink sprayed by the printing section 6 is performed. The ink drying section 7 has a drying cylinder 71 around which the continuous paper 9 is wound, and a plurality of nozzles 72 for blowing hot air onto the continuous paper 9 wound around the drying cylinder 71. The ink drying section 7 may have a drying box (not shown) for accommodating the drying cylinder 71, the nozzles 72, and the like therein in order to improve drying efficiency.

Instead of the drying with hot air, drying by emission of infrared rays may be used, or drying by using the drying cylinder 71 as a heating roll may be used. As the heating roll, a roll in which a heater for heating is incorporated is used in order to heat a surface of the roll. The drying cylinder 71 may be an adsorption type roll. As the adsorption type roll, for example, a roll is used in which an adsorption hole for adsorbing the continuous paper is provided on the surface of the roll, and the continuous paper 9 being transported is held by being sucked by a negative pressure generator (vacuum pump, blower, or the like) installed outside the printing machine.

In the winding section 8, the continuous paper 9 on which an image is formed is wound. The winding section 8 has a winding roll 81 for winding the continuous paper 9 into a roll form. The winding roll 81 is a drive roller driven by a motor or the like, and winds the continuous paper 9 while giving a constant tension to the continuous paper 9 by being driven.

Next, the pass roller 21 included in the transport section 2 will be described. In the present embodiment, two pass rollers 21 are disposed between the precoat drying section 5 and the printing section 6, and one roller 22 is disposed between the two pass rollers 21. The two pass rollers 21 come into contact with the printing surface (that is, the surface on which the precoat liquid is applied) of the continuous paper 9, dry the applied precoat liquid while changing the direction of the continuous paper 9 carried out from the precoat drying section 5 together with the roller 22, and feed it to the printing section 6.

In the present embodiment, a material of the pass roller 21 is not particularly limited, but is stainless steel, carbon steel, aluminum, or the like. In a case where a surface of the pass roller 21 is a metal base, the undried precoat liquid is likely to adhere to the pass roller 21. Therefore, in the present embodiment, the surface of the pass roller 21 is subjected to water-repellent finishing for the precoat liquid. Specifically, the surface of the pass roller 21 is coated with a material in which a difference between surface free energy of the surface of the pass roller 21 and surface free energy of the precoat liquid is 10 to 35 mN/m. In the present embodiment, a coating thickness is 20 to 400 μm.

As the precoat liquid used in the present embodiment, a strongly acidic solution containing a solvent, an antifoaming agent, a polymer, a latex, a rust inhibitor, and water and having surface free energy of 25 to 45 mN/m is used, although it is not particularly limited.

In the present embodiment, in a case where the difference between the surface free energy of the surface of the pass roller 21 and the surface free energy of the precoat liquid is 10 to 35 mN/m, the surface free energy of the surface of the pass roller 21 may be larger or the surface free energy of the precoat liquid may be larger. As coating having the surface free energy smaller than that of the precoat liquid, fluororesin coating is used. In addition, coating having the surface free energy larger than that of the precoat liquid is not particularly limited, and examples thereof include polyimide coating and polyvinyl alcohol (PVA) coating.

Here, in a case where the drying by the precoat drying section 5 is weakened, the undried precoat liquid is likely to adhere to the surface of the pass roller 21. In particular, in a case where the continuous paper 9 is coated paper, the precoat liquid is less likely to permeate a base material, so that the undried precoat liquid is more likely to adhere to the surface of the pass roller 21.

According to the present embodiment, by setting the difference between the surface free energy of the surface of the pass roller 21 and the surface free energy of the precoat liquid to 10 to 35 mN/m, the undried precoat liquid is less likely to adhere to the surface of the pass roller 21 even though the drying by the precoat drying section 5 is weakened. Therefore, even though the drying in the precoat drying section 5 is weakened, a state in which blocking is less likely to occur can be realized. In particular, in a case where the precoat liquid contains a latex which is likely to generate a foreign matter causing blocking, the effect of preventing the occurrence of blocking is large. Since the pass roller 21 is made of metal, rust is less likely to occur on the pass roller 21 by making the precoat liquid difficult to adhere to the pass roller 21, so that durability of the pass roller 21 can be enhanced. In addition, the undried precoat liquid can be smoothed by coming into contact with the surface of the pass roller 21. As a result, image quality failure due to uneven application of the precoat liquid can be suppressed. In addition, since the drying by the precoat drying section 5 can be weakened, a temperature of the continuous paper 9 carried into the printing section 6 can be lowered. Therefore, it is possible to prevent the occurrence of streak-like image failure due to dew condensation in the vicinity of jetting nozzles of the inkjet heads 63Y to 63K.

By setting a coating thickness of the water-repellent finishing on the surface of the pass roller 21 to 20 to 400 μm, the coating functions as a heat insulating member. Therefore, even though the continuous paper 9 fed from the precoat drying section 5 comes into contact with the pass roller 21, a rise in a temperature of the pass roller 21 can be suppressed. Therefore, it is easy to lower the temperature of the continuous paper 9 until the continuous paper 9 fed from the precoat drying section 5 is carried into the printing section 6, and as a result, it is possible to prevent the occurrence of streak-like image failure due to dew condensation in the vicinity of the jetting nozzles of the inkjet heads 63Y to 63K.

In a case where the printing machine is operated, the precoat liquid applied due to the occurrence of trouble other than normal operation may be transported in an undried state. In this case, although it is necessary to clean the pass roller 21, the pass roller 21 is less likely to get dirty by applying water-repellent finishing for the precoat liquid on the surface of the pass roller 21, so that a cleaning frequency of the pass roller 21 can be reduced. Even in a case of cleaning the pass roller 21, a time required for cleaning can be shortened.

In a case where the difference between the surface free energy of the surface of the pass roller 21 and the surface free energy of the precoat liquid is less than 10 mN/m, the undried precoat liquid is likely to adhere to the surface of the pass roller 21, and the occurrence of blocking cannot be sufficiently prevented. In addition, the difference between the surface free energy of the surface of the pass roller 21 and the surface free energy of the precoat liquid is 35 mN/m or more, a cost of the material for coating the surface of the pass roller 21 increases.

In a case where the coating thickness of the water-repellent finishing on the surface of the pass roller 21 is less than 20 μm, durability of the coating is weakened, and a possibility of the coating being broken is increased in a case of continuous operation for several hours or the occurrence of trouble. In a case where the coating thickness of the water-repellent finishing on the surface of the pass roller 21 exceeds 400 μm, a cost for the coating increases.

In the present embodiment, a surface roughness (arithmetic surface roughness) Ra of the pass roller 21 subjected to the water-repellent finishing is 0.1 to 1.6. By setting the surface roughness Ra to 0.1 to 1.6, a contact angle with liquid droplets on the surface of the pass roller 21 can be increased, whereby the difference between the surface free energy of the surface of the pass roller 21 and the surface free energy of the precoat liquid is more remarkable. Therefore, it is possible to enhance the above-described effect of suppressing the occurrence of blocking and preventing the occurrence of streak-like image quality failure.

In a case where the surface roughness Ra is smaller than 0.1, the effect of increasing the contact angle with the liquid droplets on the surface of the pass roller 21 cannot be sufficiently obtained. In addition, in a case where the surface roughness Ra is larger than 1.6, the continuous paper 9 that comes into contact with the surface of the pass roller 21 is damaged, and blocking is likely to occur. The unevenness of the surface of the pass roller 21 is clogged with dust, which becomes a foreign matter and causes blocking.

In the present embodiment, the pass roller 21 has a diameter of 40 to 200 mm By setting the diameter of the pass roller 21 to 40 to 200 mm, the apparatus can be made compact and inexpensive while maintaining the strength of the pass roller 21. In a case where the diameter of the pass roller 21 is less than 40 mm, it is difficult to maintain the strength of the pass roller 21. In addition, in a case where the diameter of the pass roller 21 exceeds 200 mm, the size of the pass roller 21 increases, so that it is difficult to make the apparatus compact and inexpensive.

In the present embodiment, a wrap angle of the continuous paper 9 with respect to the pass roller 21 is 45 to 215 degrees. By setting the wrap angle of the continuous paper 9 with respect to the pass roller 21 to 45 to 215 degrees, holding force of the continuous paper 9 by the pass roller 21 can be secured while reducing a time for which the surface of the pass roller 21 and the continuous paper 9 are in contact with each other. Since the time for which the surface of the pass roller 21 and the continuous paper 9 are in contact with each other is reduced, a possibility that a foreign matter causing blocking adheres to the pass roller 21 can be reduced. In a case where the wrap angle of the continuous paper 9 with respect to the pass roller 21 is less than 45 degrees, a degree to which the transport path of the continuous paper 9 is changed decreases, so that it is difficult to make the apparatus compact. In addition, in a case where the wrap angle of the continuous paper 9 with respect to the pass roller 21 exceeds 215 degrees, the time for which the surface of the pass roller 21 and the continuous paper 9 are in contact with each other increases, so that the possibility that a foreign matter causing blocking adheres to the pass roller 21 increases.

In the present embodiment, a transport tension of the continuous paper 9 is 200 to 580 N/m. In the present embodiment, a first tension sensor 25 is attached to the pass roller 21 on an upstream side of the transport path among the two pass rollers 21, and a second tension sensor 26 is attached to the roller 23 between the ink drying section 7 and the winding section 8. Then, the transport tension of the continuous paper 9 is detected by the first and second tension sensors 25 and 26, and motors and the like of the unwinding roll 31 and the winding roll 81 are adjusted such that the transport tension is 200 to 580 N/m, to pull the continuous paper 9 more strongly or less weakly.

By setting the transport tension of the continuous paper 9 to 200 to 580 N/m, the physical adhesion between the various rollers on the transport path of the continuous paper 9 and the continuous paper 9 can be reduced while preventing slipping between the printing cylinder 61 and the continuous paper 9. Since the adhesion can be reduced, the possibility that a foreign matter causing blocking adheres to the pass roller 21 can be reduced. In a case where the transport tension of the continuous paper 9 is less than 200 N/m, it is difficult to keep a difference between the tension of the continuous paper 9 on the upstream side and the tension of the continuous paper 9 on the downstream side of the printing cylinder 61 within several N, so that slipping between the printing cylinder 61 and the continuous paper 9 occurs, which increases the possibility of the occurrence of image quality failure. In a case where the transport tension of the continuous paper 9 exceeds 580 N/m, the physical adhesion between the various rollers on the transport path of the continuous paper 9 and the continuous paper 9 increases, so that the possibility that a foreign matter causing blocking adheres to the pass roller 21 increases.

In the present embodiment, an evaporation rate of water contained in the precoat liquid in the continuous paper 9 carried into the printing section 6 is 25% to 75% by mass. By setting the evaporation rate of water contained in the precoat liquid to 25% to 75% by mass, the drying by the precoat drying section 5 can be weakened, so that the temperature of the continuous paper 9 carried into the printing section 6 can be lowered. Therefore, it is possible to prevent the occurrence of streak-like image failure due to dew condensation in the vicinity of the jetting nozzles of the inkjet heads. In a case where the evaporation rate of water contained in the precoat liquid is less than 25% by mass, the amount of undried precoat liquid on the surface of the continuous paper 9 increases, so that the possibility of the occurrence of image quality failure due to uneven application of ink increases. Since the undried precoat liquid is likely to adhere to the surface of the pass roller 21, the occurrence of blocking cannot be sufficiently suppressed. In addition, in a case where the evaporation rate of water contained in the precoat liquid exceeds 75% by mass, the continuous paper 9 carried into the printing section 6 reaches a high temperature, so that the possibility of the occurrence of streak-like image failure due to dew condensation in the vicinity of the jetting nozzles of the inkjet heads increases.

In the present embodiment, a path length between the pretreatment section 4 and the printing section 6 is 1 to 5 m. By setting the path length between the pretreatment section 4 and the printing section 6 to 1 to 5 m, the temperature of the continuous paper 9 that has reached a high temperature by the precoat drying section 5 can be sufficiently lowered, so that the occurrence of streak-like image failure due to dew condensation in the vicinity of the jetting nozzles of the inkjet heads can be prevented. In addition, the apparatus can be made compact. In a case where the path length between the pretreatment section 4 and the printing section 6 is less than 1 m, the temperature of the continuous paper 9 carried into the printing section 6 cannot be sufficiently lowered, so that the possibility of the occurrence of streak-like image failure due to dew condensation in the vicinity of the jetting nozzles of the inkjet heads increases. In a case where the path length between the pretreatment section 4 and the printing section 6 exceeds 5 m, it is difficult to make the apparatus compact.

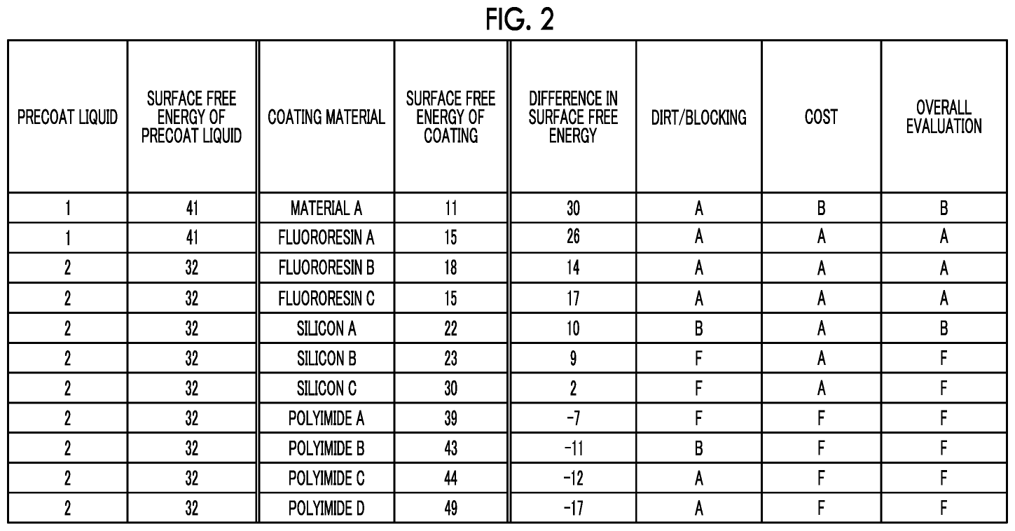

Next, evaluation results according to the present disclosure will be described. FIG. 2 is a table showing evaluation results of the difference between the surface free energy of various coating materials applied to the surface of the pass roller 21 and the surface free energy of the precoat liquid. As shown in FIG. 2, two types of precoat liquids 1 and 2 different in surface free energy were used as the precoat liquid. As the coating material on the surface of the pass roller 21, a material A, three types of fluororesins A to C, three types of silicon A to C, and four types of polyimides A to D were used. The material A is a coating agent obtained by dissolving a fluororesin in a solvent.

In addition, FIG. 2 shows the evaluation of dirt and blocking, the evaluation of a cost, and the overall evaluation. The evaluation is shown in three stages of A, B, and F, in which A and B represent pass and F represents failure. As shown in FIG. 2, by using the material in which the difference between the surface free energy of the surface of the pass roller 21 and the surface free energy of the precoat liquid is 10 to 35 mN/m, all of the evaluation of dirt and blocking, the evaluation of a cost, and the overall evaluation were A or B. The polyimides B, C, and D satisfying the difference in surface free energy of 10 to 35 mN/m from the precoat liquid were evaluated as F in the overall evaluation, but were evaluated as A and B in the evaluation of dirt and blocking. Therefore, the polyimides B, C, and D can be used for coating the surface of the pass roller 21 of the image forming apparatus according to the present disclosure, in a case where the cost is not taken into consideration.

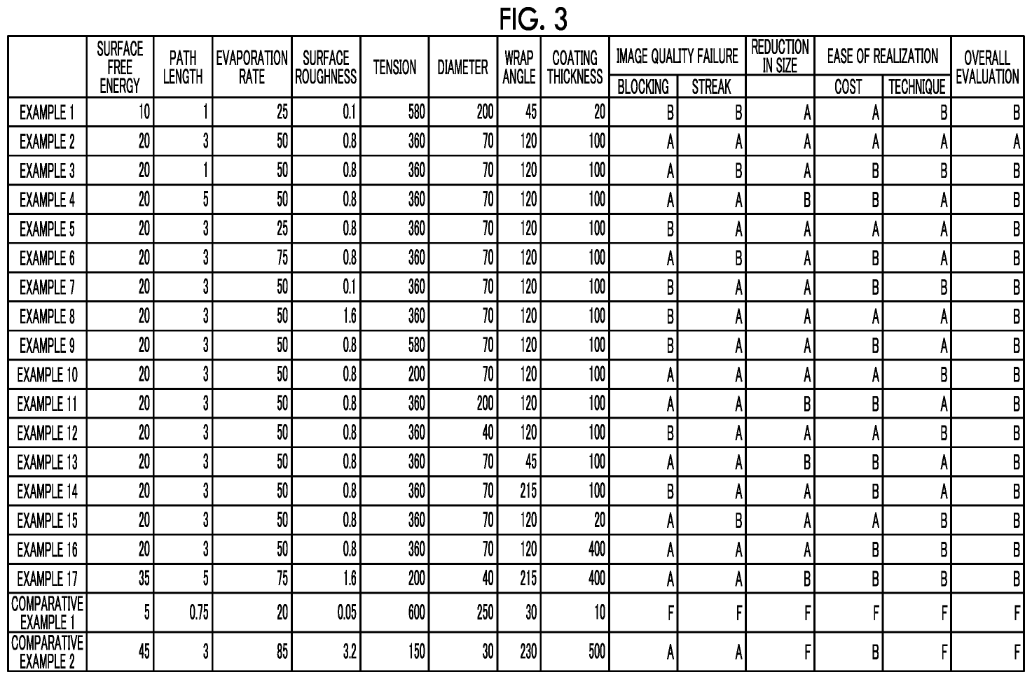

FIG. 3 is a table showing evaluation results of various conditions in an image forming apparatus according to the present disclosure. In FIG. 3, the term “surface free energy” represents the difference (unit: mN/m) between the surface free energy of the surface of the pass roller 21 and the surface free energy of the precoat liquid. The term “path length” represents the path length (unit: m) between the pretreatment section 4 and the printing section 6. The term “evaporation rate” represents the evaporation rate (unit: % by mass) of water contained in the precoat liquid. The term “surface roughness” represents the surface roughness Ra of the pass roller 21. The term “tension” represents the transport tension (unit: N/m) of the continuous recording medium. The term “diameter” represents the diameter (unit: mm) of the pass roller 21. The term “wrap angle” represents the wrap angle of the continuous recording medium with respect to the pass roller 21. The term “coating thickness” represents the coating thickness on the surface of the pass roller 21 (unit: μm).

FIG. 3 shows 17 kinds of Examples 1 to 17 and two kinds of Comparative Examples 1 and 2. In Example 1, the values of the surface free energy, the path length, the evaporation rate, the surface roughness, the tension, the diameter, the wrap angle, and the coating thickness (hereinafter, referred to as parameters) are the minimum values, in Example 2, the values of the parameters are the intermediate values, and in Example 17, the values of the parameters are the maximum values. The path lengths in Examples 3 and 4 are the minimum value and the maximum value, respectively, and the evaporation rates in Examples 5 and 6 are the minimum value and the maximum value, respectively. The surface roughnesses in Examples 7 and 8 are the minimum value and the maximum value, respectively, and the tensions in Examples 9 and 10 are the maximum value and the minimum value, respectively. The diameters of the pass roller 21 in Examples 11 and 12 are the maximum value and the minimum value, respectively, and the wrap angles in Examples 13 and 14 are the minimum value and the maximum value, respectively. The coating thicknesses in Examples 15 and 16 are the minimum value and the maximum value, respectively. In addition, in Examples 3 to 16, the parameters other than the parameters to be the maximum value and the minimum value are the intermediate values.

In Comparative Example 1, the difference in surface free energy, the path length, the evaporation rate, the surface roughness, the wrap angle, and the coating thickness are in a range smaller than the range specified in the present disclosure, and the tension and the diameter are in a range larger than the range specified in the present disclosure. In Comparative Example 2, the difference in surface free energy, the path length, the evaporation rate, the surface roughness, the wrap angle, and the coating thickness are in a range larger than the range specified in the present disclosure, and the tension and the diameter are in a range smaller than the range specified in the present disclosure.

FIG. 3 shows evaluation results from the viewpoint of image quality failure, reduction in size of the apparatus, and ease of realization. For the image quality failure, the evaluation results from the viewpoint of blocking and streak-like image quality failure (indicated as streak) are shown. For the ease of realization, the evaluation results from the viewpoint of cost and technique are shown. The evaluation results are shown in three stages of A, B, and F, in which A and B represent pass and F represents failure.

As shown in FIG. 3, all the evaluations were A and B for all Examples 1 to 17. Regarding Comparative Example 1, all the evaluations were F. Regarding Comparative Example 2, the evaluation of image quality failure and cost was pass, but the evaluation of reduction in size and technique, and the overall evaluation were failure.

From the above, it was confirmed that by satisfying various conditions in the image forming apparatus according to the present disclosure, it is possible to prevent streak-like image quality failure and blocking while reducing the size of the apparatus.

As described above, the image forming apparatus according to the embodiment of the present disclosure has been described with reference to the drawings, but the image forming apparatus is not limited to those shown in the drawings, and can be appropriately redesigned within a range not deviating from the gist of the present disclosure.

For example, in the above embodiment, the number of the pass rollers 21 disposed between the precoat drying section 5 and the printing section 6 is not limited to two, but may be one, or may be three or more.

In addition, in the above embodiment, the precoat drying section 5 is provided between the pretreatment section 4 and the printing section 6, but the precoat drying section 5 need not be provided in a case where the path length can be secured such that the evaporation rate of water contained in the precoat liquid is 25% to 75% by mass in the continuous paper 9 immediately before being carried into the printing section 6.

Further, in the above embodiment, coated paper is used as the continuous paper 9, but the present invention is not limited thereto, and plain paper may be used.

What is claimed is:

1. An image forming apparatus comprising:
a pretreatment section that applies a precoat liquid to a printing surface of a continuous recording medium to be transported;
a printing section that sprays ink onto the continuous recording medium to which the precoat liquid is applied; and
a transport section that transports the continuous recording medium along a predetermined path,
wherein the transport section includes at least one pass roller that is disposed between the pretreatment section and the printing section, the pass roller transporting the continuous recording medium to which the precoat liquid is applied toward the printing section and coming into contact with the printing surface of the continuous recording medium,
a surface of the pass roller is subjected to water-repellent finishing for the precoat liquid,
wherein a difference between surface free energy on the surface of the pass roller and surface free energy of the precoat liquid is 10 to 35 mN/m,
wherein a surface roughness Ra of the pass roller is 0.1 to 1.6,
wherein a wrap angle of the continuous recording medium with respect to the pass roller is 45 to 215 degrees,
wherein a transport tension of the continuous recording medium is 200 to 580 N/m, and
wherein an evaporation rate of water contained in the precoat liquid in the continuous recording medium carried into the printing section is 25% to 75% by mass.

2. The image forming apparatus according to claim 1, further comprising:
a drying section that is provided between the pretreatment section and the pass roller and dries the continuous recording medium to which the precoat liquid is applied.

3. The image forming apparatus according to claim 1,
wherein a coating thickness on the surface of the pass roller by the water-repellent finishing is 20 to 400 μm.

4. The image forming apparatus according to claim 1,
wherein the water-repellent finishing is coating with a fluororesin.

5. The image forming apparatus according to claim 1,
wherein the pass roller has a diameter of 40 to 200 mm.

6. The image forming apparatus according to claim 1,
wherein a path length between the pretreatment section and the printing section is 1 to 5 m.

7. The image forming apparatus according to claim 1,
wherein the precoat liquid contains a latex.

8. The image forming apparatus according to claim 1,
wherein the continuous recording medium is coated paper.
